(19) United States
(12) Patent Application Publication
(10) Pub. No.: US 2009/0125386 A1
(43) Pub. Date: May 14, 2009

(54) SYSTEM AND METHOD OF OPERATING A CUSTOMER LOYALTY PROGRAM

(75) Inventors: Jason James Willison, Dianella (AU); Roshunkumar Dayanand Chirkoot, Dianella (AU)

Correspondence Address: NIXON & VANDERHYE, PC, 901 NORTH GLEBE ROAD, 11TH FLOOR, ARLINGTON, VA, 22203, US

(73) Assignee: WILLCORP ENTERPRISES PTY LTD, Dianella, W.A. (AU)

(21) Appl. No.: 11/720,388

(22) PCT Filed: Dec. 2, 2005
(86) PCT No.: PCT/AU2005/001814

§ 371 Date: May 29, 2007

(30) Foreign Application Priority Data
Dec. 3, 2004 (AU) 2004906911

(51) Int. Cl. G06Q 30/00; G06Q 40/00

(52) U.S. Cl. 705/14

(57) ABSTRACT

A system and method for operating a customer loyalty program including a computer system accessible on-line by various institutions participating in the customer loyalty program. The computer system includes a data-processing facility for processing inter alia, information relating to participating customers and their loyalty accounts, and information relating to participating institutions. The computer system further includes a storage facility for storing a database of participating customers' information, as well as other relevant information. The system also includes a facility for managing the transfer of relevant information from participating customers and institutions, and for managing the maintenance of the database information stored in the storage facility, including the application of discounted rates of interest to selected financial instruments. The system and method of the invention typically envisages two types of participating institutions, a financial institution shown as lender and a retail institution shown as merchant.

### FIELD OF THE INVENTION

The present invention relates to a method and system of operating a customer loyalty program in which the benefits of customer loyalty are linked to a discounted rate of interest on a customer's mortgage, loan, credit card or other type of financial instrument.

### BACKGROUND TO THE INVENTION

Over recent decades there has been a burgeoning of customer loyalty programs into almost every kind of business in the marketplace, driven by the popularity of frequent flyer programs introduced by commercial airlines and the proliferation of credit cards. By using their credit card, or by presenting their loyalty program membership card, at the point of sale when making purchases at particular stores, the customer can accumulate loyalty points that can be converted to frequent flyer points with designated airlines, or redeemed to purchase award items, when a designated threshold total number of points have been accumulated.

Recently several supermarket chains have introduced customer loyalty programs that reward customers with a discount voucher for the purchase price of petrol at designated petrol stations, if they purchase in excess of a designated minimum total value of goods in a single transaction. This arrangement benefits both the supermarket chains and the petroleum companies as it encourages customers to purchase their groceries and petrol exclusively at their proprietary retail outlets.

One of the disadvantages of many prior art customer loyalty programs is that they are somewhat indiscriminate in the manner in which they reward customer “loyalty”. Provided a customer makes a purchase that exceeds a preset minimum threshold value, or present their appropriate membership card, they will receive loyalty points that count towards a benefit, whether or not they have ever shopped at that particular retail chain before, and whether on not they ever shop at that particular retail chain again. In other words, customers are not being rewarded for loyalty; they are simply being rewarded for patronising that particular retail chain on that particular occasion.

The present invention was developed with a view to providing a method and system of operating a customer loyalty program in which the benefits awarded to customers are on-going and continuous, and are more directly linked to customer loyalty, and therefore encourage greater customer loyalty.

References to prior art in this specification are provided for illustrative purposes only and are not to be taken as an admission that such prior art is part of the common general knowledge in Australia or elsewhere.

### SUMMARY OF THE INVENTION

According to a first aspect of the present invention there is provided a method of operating a customer loyalty program, the method comprising:

registering a unique identifier allocated to a customer participating in the customer loyalty program;

establishing a customer loyalty account linked to said unique identifier for accumulating customer loyalty points earned by the participating customer;

transferring or establishing a financial instrument for the participating customer to/with a participating institution of a first type;

awarding customer loyalty points to the participating customer based on the value and/or quantity of purchases performed by said customer with one or more participating institutions of a second type using their unique identifier;

providing a discounted rate of interest applied to said financial instrument based on said customer achieving a predetermined loyalty point threshold within a periodic specified time interval; and

monitoring said customer loyalty account to ensure that the total of the loyalty points accrued during each one of said periodic specified time intervals exceeds said predetermined threshold whereby the customer may continue to enjoy the benefit of said discounted rate of interest applied to said financial instrument.

Preferably the first type of participating institution is a financial institution such as a bank, building society or insurance company.

Preferably the financial instrument is a financial debt instrument such as a mortgage, loan, overdraft or credit card.

Preferably the second type of participating institution is a retail institution such as a supermarket chain, fast food chain, electrical goods business or personal services company, or a business engaging in internet based commerce.

Preferably said step of monitoring said customer loyalty account also involves resetting the balance of points in the customer loyalty account by at least the predetermined loyalty points threshold at the end of each said periodic specified time interval. Preferably loyalty points accrued in excess of said predetermined loyalty point threshold can be carried forward into subsequent periodic specified time intervals. Typically, in the event that the predetermined threshold is not reached in the periodic specified time interval, an adjustment is made retrospectively in the discounted interest rate applied during that period, charged back at normal or non-discounted rates. Typically, in any subsequent periodic specified time interval, immediately following the period in which the predetermined threshold in the participating customer's loyalty account was not reached, the customer does not receive said discounted rate of interest on their financial instrument. Preferably no limit is set on the number of periods during which the customer may fail to reach the predetermined threshold of loyalty points, however the customer does not receive the benefit of the reduced rate of interest during those periods.

Advantageously loyalty points accrued by participating customers above threshold levels may entitle them to further discounts, vouchers, incentives and benefits. Preferably, if a participating customer's loyalty point account balance reaches beyond the minimum threshold limit within the periodic specified time interval, they may be awarded separate status points which are transferred to a separate status point account. Advantageously, upon achieving a predetermined threshold level of status points the participating customer may be entitled to accrue loyalty points at a higher rate.

Alternatively, a participating customer may be entitled to another type of benefit, discount or promotion offered by the participating institutions instead of or as well as the usual loyalty points awarded for the transaction. For example, a participating institution may alter the value or number of points earned by customers in a particular transaction. It is envisaged that this would have application in the case of the participating institution being a retail institution and offering a special promotion where the purchase of an item would attract a bonus issue of points, or where the points that would normally be earned from the purchase of the item are multiplied by a certain factor for a limited period of time.

According to a second aspect of the present invention there is provided a system for operating a customer loyalty program, the system comprising:

means for allocating a unique identifier to a customer participating in the customer loyalty program;

means for establishing a customer loyalty account linked to said unique identifier for accumulating customer loyalty points earned by the participating customer;

means for transferring or establishing a financial instrument for the participating customer to/with at least one participating institution of a first type;

means for awarding customer loyalty points to the participating customer based on the value and/or quantity of purchases performed by said customer with one or more participating institutions of a second type using their unique identifier;

means for providing a discounted rate of interest applied to said financial instrument based on said customer achieving a pre-determined loyalty points threshold within a periodic specified time interval; and

means for monitoring said customer loyalty account to ensure that the total of the loyalty points accrued during each subsequent one of said periodic specified time intervals exceeds said predetermined threshold whereby the customer may continue to enjoy the benefit of said discounted rate of interest applied to said financial instrument.

Preferably the first type of participating institution is typically a financial institution such as a bank, building society or insurance company. Preferably the financial instrument is a financial debt instrument such as a mortgage, loan, overdraft or credit card. The participating financial institution is typically able to access the customer loyalty account in order to confirm the continuing eligibility of a customer to a discounted rate of interest on the financial instrument.

The second type of participating institution is typically a retail institution such as a supermarket chain, fast food chain, electrical goods business or personal services company, or a business engaging in internet based commerce. Participating retail institutions are typically provided with a verification means for verifying a customer's unique identifier in order to facilitate the customer's purchases and transactions, and an input device to facilitate the transfer of transaction information relating to the customer's purchases or other commercial transactions. Preferably the verification means is in the form of a magnetic card reader, and the input device is a data transmission device with built-in modem to facilitate the transmission of the customer's transaction information over the public telephone network. Advantageously any one participating institution may embody both types of institution.

Preferably the means for awarding customer loyalty points includes a facility to allow the participating institution to vary the value and/or number of loyalty points awarded. For example, in the case of the participating institution being a retail institution, an item may be purchased as a special promotion with the award of bonus points.

According to a third aspect of the present invention there is provided a computer system for operating a customer loyalty program, the computer system comprising:

a data processing facility for processing information relating to identification of participating customers, information relating to participating institutions of a first type to which financial instruments are transferred or established for participating customers, information relating to participating customers' loyalty accounts wherein the loyalty accounts include loyalty points awarding to the participating customer based on the value and/or quantity of purchases performed by said customer with one or more participating institutions of a second type using their unique identifier, and information relating to customers financial instruments;

a storage facility for storing a database of participating customers' information, a database of participating institutions' information, a database of participating customers' loyalty accounts, and a database of customer's financial instruments information;

a facility for managing the transfer of relevant information from participating customers and institutions and for managing the maintenance of said database information stored in said storage facility, including the application of discounted rates of interest to selected financial instruments; and,

a facility for monitoring said database of customers' loyalty accounts to ensure that the total of the loyalty points accrued during periodic specified time intervals is maintained above a predetermined threshold whereby customers may continue to enjoy the benefit of said discounted rates of interest applied to said selected financial instruments.

Preferably the computer system further comprises a facility for managing on-line access of information stored in the storage facility.

Preferably the financial instrument is a financial debt instrument such as a mortgage, loan, overdraft or credit card.

Throughout the specification, unless the context requires otherwise, the word “comprise” or variations such as “comprises” or “comprising”, will be understood to imply the inclusion of a stated integer or group of integers but not the exclusion of any other integer or group of integers.

### BRIEF DESCRIPTION OF THE DRAWINGS

The nature of the invention will be better understood from the following detailed description of several specific embodiments of the system and method of operating a customer loyalty program, given by way of example only, with reference to the accompanying drawings, in which:

FIG. 1 is a schematic block diagram of a preferred embodiment of a system for operating a customer loyalty program in accordance with the present invention;

FIG. 2 is a diagram illustrating a typical network of participants in the system for operating a customer loyalty program of FIG. 1;

FIG. 3 is flow chart illustrating a preferred sequence of steps in a method of operating a customer loyalty program in accordance with the present invention;

FIG. 4 is a flow chart illustrating in greater detail a preferred sequence of steps in the application phase of the method of FIG. 3;

FIG. 5 is a flow chart illustrating in greater detail a preferred sequence of steps in the approval phase of the method of FIG. 3;

FIG. 6 is a flow chart illustrating in greater detail a preferred sequence of steps in the conveyance phase of the method of FIG. 3;

FIG. 7 is a flow chart illustrating in greater detail a preferred sequence of steps in the operation phase of the method of FIG. 3;

FIG. 8 is a flow chart illustrating in greater detail a preferred sequence of steps in the administration phase of the method of FIG. 3; and,

FIG. 9 is a flow chart illustrating in greater detail a preferred sequence of steps in the status phase of the method of FIG. 3;

### DETAILED DESCRIPTION OF PREFERRED EMBODIMENTS

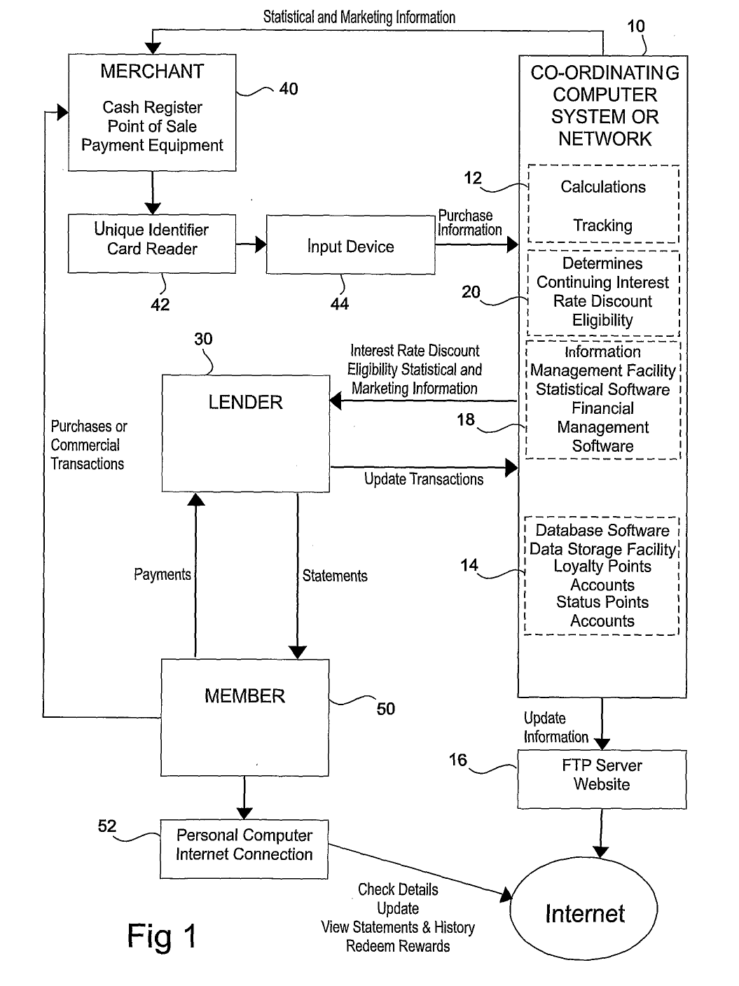

A preferred embodiment of a system for operating a customer loyalty program in accordance with the present invention, as illustrated in FIG. 1, comprises a computer system 10 which is accessible on-line by various institutions participating in the customer loyalty program. The computer system 10 may be housed in a centralised location or may comprise a network of computers distributed geographically in various locations. It typically comprises a number of facilities that may be in the form of hardware and/or software components for facilitating the various aspects of the customer loyalty program. The computer system 10 includes a data-processing facility 12 for processing inter alia, information relating to participating customers, information relating to participating institutions, information relating to participating customers' loyalty accounts, and information relating to customers' financial instruments.

The computer system 10 further comprises a storage facility 14 for storing a database of participating customers' information, a database of participating institutions' information, a database of participating customers' loyalty accounts including loyalty points, a database of participating customers' status points accounts, and a database of customer's financial instruments information. The system 10 preferably also comprises a facility 16 for managing on-line access of information stored in the storage facility, which may include a file transfer protocol (FTP) server for managing on-line access via the internet using a website as the customer interface. Obviously suitable firewall protection and other security measures are provided in the computer system 10 for inhibiting unauthorised access and hacking into the system.

Preferably the computer system 10 also includes a facility 18 for managing the transfer of relevant information from participating customers and institutions, and for managing the maintenance of the database information stored in the storage facility 14, including the application of discounted rates of interest to selected financial instruments. The information management facility 18 may include proprietary financial management software and statistical software. Typically a software facility 20 is also provided for monitoring the database of customers' loyalty accounts to ensure that the total of the loyalty points accrued during periodic specified time intervals is maintained above a predetermined threshold, whereby customers may continue to enjoy the benefit of discounted rates of interest applied to selected financial instruments.

The system and method of operating the preferred customer loyalty scheme typically envisages two types of participating institutions, although any one participating institution may embody both types of institution. The first type of participating institution is typically a financial institution such a bank, building society or insurance company, illustrated in FIG. 1 as lender 30, which is able to provide a financial instrument such a mortgage, loan or credit card. The participating financial institution 30 is typically able to access the computer system 10 in order to confirm the continuing eligibility of a customer to a discounted rate of interest on the financial instrument.

The second type of participating institution is typically a retail institution such as a supermarket chain, fast food chain, electrical goods business or personal services company, or a business engaging in internet based commerce, illustrated in FIG. 1 as merchant 40. Merchants 40 having associated cash register and point of sale equipment, are typically provided with statistical and marketing information from the computer system 10. This statistical and marketing information is obtained from an analysis of participating customers' emerging purchasing patterns, and observable trends in the manner of conducting other financial transactions.

A customer participating in the customer loyalty program is illustrated in FIG. 1 as member 50. Member 50 typically has on-line access via his/her personal computer 52 (with internet access) to authorised parts of the database of information stored in the storage facility 14, via the FTP server 16. Member customers 50 transfer or assume mortgages, loans, credit cards or other financial instruments to/with participating financial institutions such as lender 30. Lender 30 typically provides the member 50 with regular statements showing the current status of their financial instrument, eg. balance of mortgage and interest charged under applicable interest rates. The member 50 makes regular payments to the lender 30 in accordance with the agreed terms of the financial instrument. Member 50 is allocated a unique identifier with which he/she makes purchases or conducts other commercial transactions with participating merchants 40 in order to earn loyalty points which are credited to the member's customer loyalty account. Similarly, the member accumulates status points which are credited to the member's status points account.

Each merchant 40 is provided with means 42 for verifying a customer's unique identifier in order to facilitate the customer's purchases and transactions, and an input device 44 to facilitate the transfer of transaction information relating to the customer's purchases or other commercial transactions to the computer system 10. In the illustrated embodiment, the verification means is in the form of a magnetic card reader 42, and the input device is a data transmission device 44 with built-in modem to facilitate the transmission of the customer's transaction information over the public telephone network.

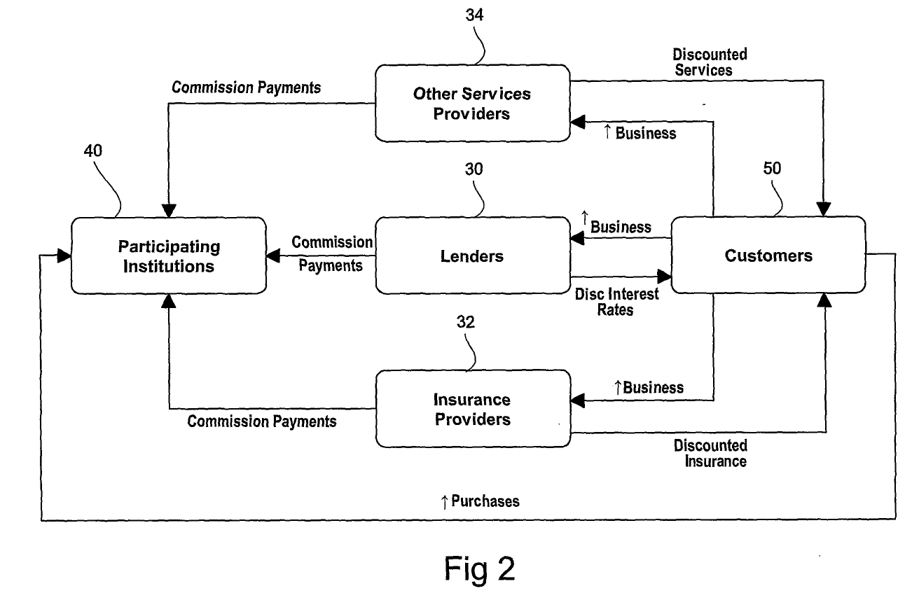

FIG. 2 illustrates a typical network of participants in the system of FIG. 1, including members (customers 50), participating financial institutions (lenders 30, insurance providers 32 and other service providers 34), and participating retail institutions (merchants 40). FIG. 2 illustrates the different types of financial transactions that typically occur between the various participants in the system. Customer member 50 can purchase a financial instrument from the lender 30 at a discounted interest rate, an insurance policy from the insurance providers 32 at a discounted premium, and services at discounted rates from the other service providers 34. The relevant discounts are only applied to these purchases provided the customer 50 has satisfied predetermined discount eligibility requirements. Each of the participating financial institutions makes appropriate commission payments to the merchant 40 under the terms of the contractual agreements between all participating institutions in the customer loyalty program. Customer member 50 must purchase goods and/or services from the participating merchant 40 in order to earn loyalty points.

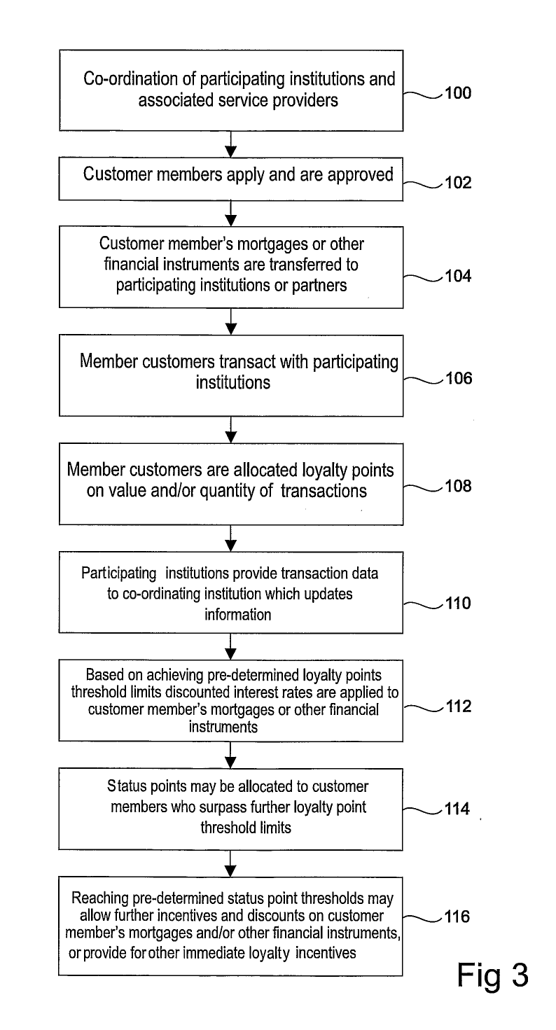

A preferred method of operating the customer loyalty program will now be described with reference to FIG. 1 and the flow charts in FIGS. 3 to 9. A prerequisite for successfully operating the customer loyalty program is the initial and ongoing coordination (100) of participating institutions and associated service providers. This coordinating function includes establishing and signing off on the terms and conditions of the various contractual obligations that exist between the participating institutions (lenders 30, insurance providers 32, other service providers 34, and merchants 40). It also includes providing each of the participating institutions with the requisite hardware and/or software facilities to enable them to be connected to the computer system 10.

Customer members 50 must apply (102) to join the customer loyalty program and the approval process may take some weeks to complete, depending on the nature of the financial instrument(s) the customer wishes to transfer or assume with the participating financial institutions 30. Potential applicants may typically source general information and/or make a general enquiry about the program via a hotline, the internet or in-store pamphlets, etc. Information requested is relayed to the potential applicant who may then consider enrolling in the program. Potential applicants are given the opportunity to follow up for further information on the program if they wish. Once the potential applicant decides to enrol in the program they must request the appropriate application documents from the program operator.

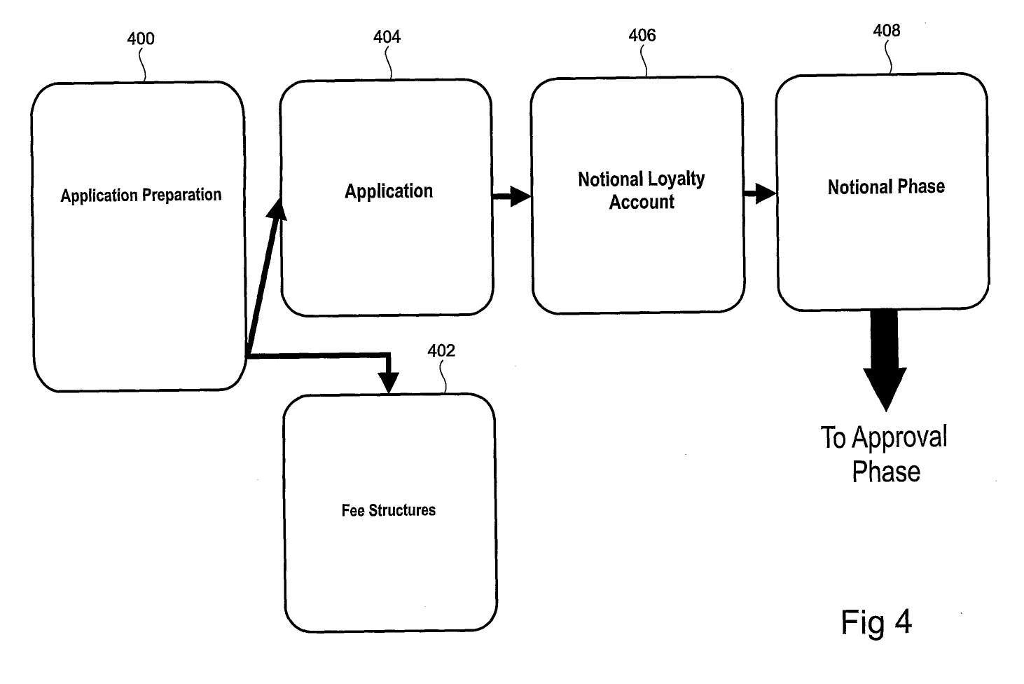

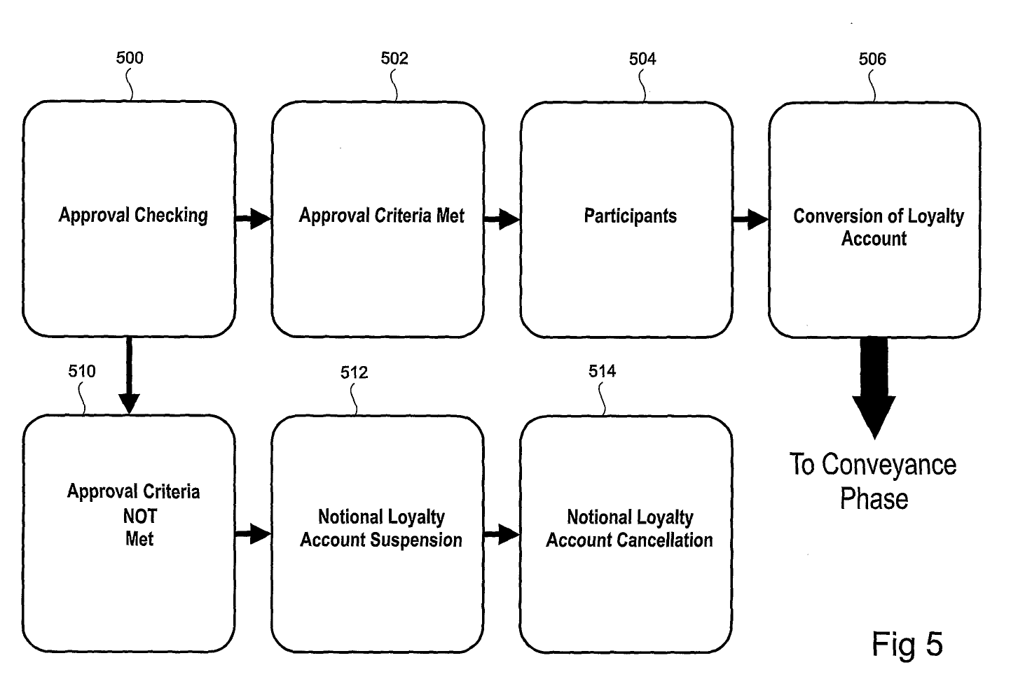

The application and approval stage (102) will be described in more detail with reference to the flow charts in FIGS. 4 and 5. The first step (400) in the application phase as illustrated in FIG. 4, typically involves preparing an application kit which is forwarded to the applicant and may include: an application form, details statement, privacy consents, credit card history check consent, consent to transfer mortgage, terms and conditions and indemnifications. The applicant must decide on the level of participation in the program, with the basic level being one loan or other financial instrument (eg. mortgage only). Further levels include additional financial instruments and/or other products. Applicants may also choose a spending commitment level; the higher the promised spending level the greater the level of loyalty discounts and bonuses to which the member will be entitled. Applicants also choose which fee structure (402) they wish to apply under. Applicants may choose to finance their transfer fees from their current lender and their application fees under a separate payment plan. Alternatively, they may choose to pay all fees up front, or roll their fees into the mortgage, or a combination of these options.

Once all the application documentation has been completed and signed by the applicants the application is lodged (404) with the operator of the program for processing. The operator will typically immediately issue (404) a unique identifier to the applicant, which they must present when making purchases for goods and services. The unique identifier may typically take the form of an alpha-numeric code imprinted on a machine readable plastic card, such as a magnetic swipe card or a smart card. At this stage the applicant's participation in the loyalty program is provisional, pending approval of their application, however issuance of the unique identifier allows them to commence accumulating loyalty points immediately. For this purpose the operator also establishes (406) a notional loyalty account in the storage facility 14 of computer system 10. The applicant may now shop, and may notionally begin to accrue loyalty points (408) which will be honoured if their application is successful.

The second phase of the application and approval stage (102) is the approval phase, which is carried out by the operator according to a typical sequence of steps as illustrated in FIG. 5. The first step in the approval phase involves reviewing (500) the application and conducting the appropriate checks against pre-determined approval criteria. The operator may have a pre-approval program in place. If all approval criteria are met, the applicant is notified (502) of the approval of their application. Applicants are now referred to (504) as “participants” or “members”. The notional loyalty account is converted (506) to a participant's loyalty account, which is stored in the database of participating customers' loyalty accounts in storage facility 14. In the event that approval criteria are not met, the application process is terminated, the notional loyalty account is suspended and the applicant advised (510) that their application has not been successful. The notional loyalty account may be suspended (512) for a specified period and may be reactivated within that period if the applicant subsequently submits another application which is successful. However, if the applicant does not reapply to enrol in the program within the specified period, the applicant's notional loyalty account is cancelled (514) and their unique identifier terminated.

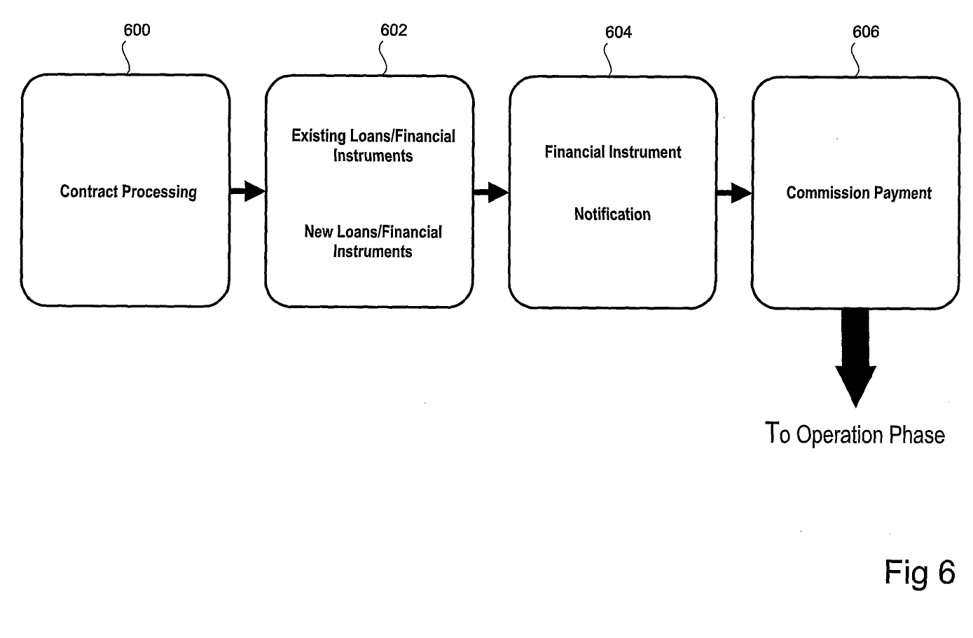

The next stage in the preferred method of operating the customer loyalty program involves the transfer (104) or establishing of customer members mortgages or other financial instruments with participating institutions or partners. This conveyance phase is illustrated in greater detail in FIG. 6. Once approval has been granted, contracts between the customer member 50 and a participating financial institution (lender 30) must be processed (600) and appropriate accounts established with the institution. The lender 30 forwards (602) transfer documents for the transfer of loans/financial instruments from the customer member's existing financial institutions, or sets up (602) new loans/financial instruments within its own system. The participating lender 30 thereby assumes or funds (604) the customer member's loans/financial instruments, and any fees become payable according to the member's agreed level of participation and fee structure. The customer member is notified (604) of new payments, status of accounts, status of loans/financial instruments and other information. This obligation to notify the customer member continues for the term of the financial instrument. The lender initiates the payment (606) of commission fees, based on established formulae, to participating merchants.

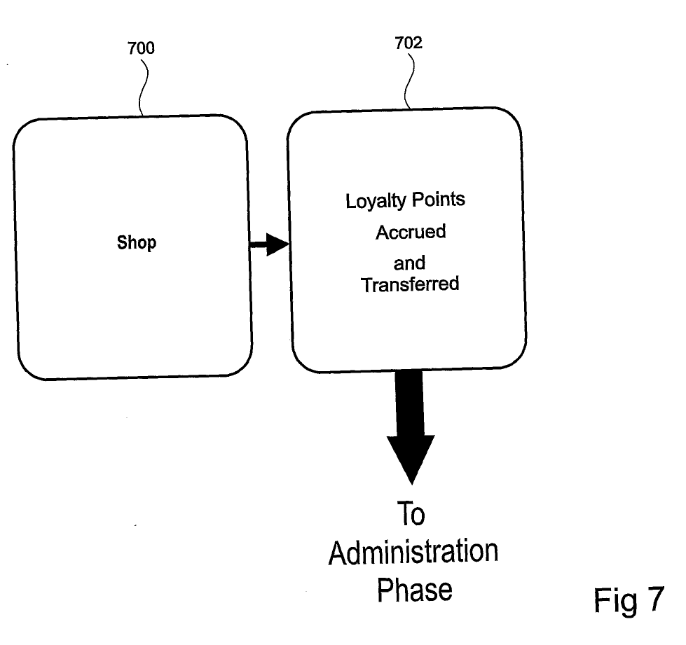

In the operation phase (106) member customers 50 transact with participating retail institutions 40 to earn (108) customer loyalty points. As shown in FIG. 7, participating customers shop (700) at participating merchants and present their unique identifier whenever they conduct a financial transaction. Loyalty points are allocated based on the value and/or quantity of the goods/services purchased and using a predetermined formula. This formula may be varied by the participating merchants as required. For example, bonus points may be awarded in the case of an item on special promotion, or usual points awarded may be multiplied by a factor for a limited period of time, both of these options providing merchanst with an effective marketing tool. Loyalty points accrued (702) are transferred to the participating customer's loyalty account.

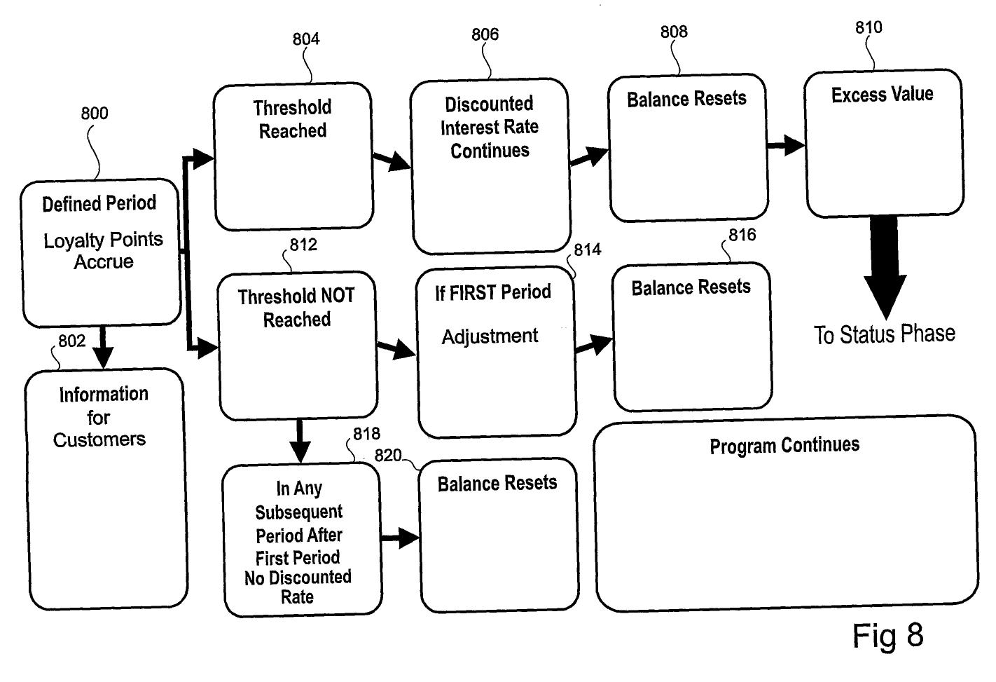

The next two stages of the preferred method of operating the customer loyalty program involve the participating retail institutions providing (110) transaction data to the operator of the program, and provided predetermined loyalty point threshold limits are achieved, the participating financial institutions applying (112) a discounted rate of interest to the customer member's mortgage or other financial instrument. The manner is which this administration phase of the method of operation is typically coordinated by the operator is illustrated in FIG. 8. As agreed by the participating customer during the application phase, the agreed loyalty point threshold must be achieved (800) during each periodic specified time interval, for example, each month, in order for the customer member to be eligible for the discounted rate of interest. Participating customers can actively manage their participation in the program by viewing (802) their loyalty account balance online, as well as by information statements received by post, SMS or other electronic means for communicating updates can also be registered for.

Provided the minimum points balance in the participating customer's loyalty account is reached (804) or surpassed in the specified period, the discounted interest rate on the customer's loan or other financial instrument continues (806) to apply during the immediately following specified period (month). At the end of each specified period the balance of the Customer's loyalty account is reset (808) by at least the minimum threshold level. Any points accrued in excess of the threshold level may be carried forward (810) to one or more subsequent specified periods. In the event that the minimum points balance (threshold level) in the participating customer's loyalty account is not reached (812) in the specified period, an adjustment (814) may be made retrospectively in the discounted interest rate applied during that period, charged back at normal or non-discounted rates. At the end of the specified period the loyalty account balance resets (816). In any subsequent period, immediately following the period in which the threshold level in the participating customer's loyalty account was not reached, the customer does not receive (818) the discounted rate of interest on their financial instrument. At the end of the subsequent period the loyalty account balance again resets (820). There is typically no limit set on the number of periods during which the customer may fail to reach the threshold level of loyalty points; however the customer does not receive the benefit of the reduced rate of interest during those periods.

The program may provide other benefits that are made available to customer members, even if they do not achieve the threshold level, based on lower point totals achieved during specified time intervals, (which may be of the same duration or different than the specified period for eligibility for the discounted interest rate). Hence it is to be understood that the program also provides for benefits and other immediate incentives to be allocated to member customers in conjunction with or in lieu of the varying discounts on mortgage or other financial instrument interest rates. The customer's membership of the program continues until the loan/financial instrument is discharged and paid; the customer refinances their loan/financial instrument; the lender sells or otherwise disposes of the customer's loan/financial instrument; the lender makes a call on the loan/financial instrument; the customer member breaches the terms of the program; the customer chooses to leave the program; or some other event that in the judgement of the operator warrants suspension or termination of membership.

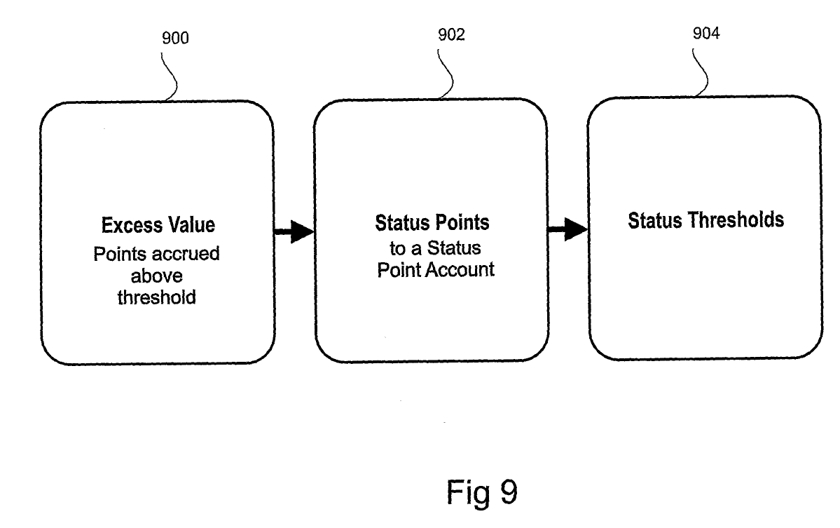

Further stages in the preferred method of operating the customer loyalty program relate to awarding (114) of “status points” to customer members who surpass further specified loyalty point threshold limits. Upon reaching predetermined status point thresholds (116) customer members may become eligible for further incentives and discounts on their mortgages and/or other financial instruments, or other immediately redeemable loyalty incentives. This is referred to as the status phase of the program, and is illustrated in more detail in the flow chart of FIG. 9. Loyalty points accrued (900) by the participating customer 50 above threshold levels may entitle them to further discounts, vouchers, incentives and benefits. If participating customers reach loyalty point account balances beyond the minimum threshold limits within the periodic specified time interval, they may be awarded (902) separate status points which are transferred to a separate Status Point Account. Upon achieving (904) a predetermined threshold level of status points the participating customer may be entitled, for example, to accrue loyalty points at a higher rate, or to another type of benefit, discount or promotion offered by the program's participating merchants and financial institutions.

Now that a preferred embodiment of the system and method for operating a customer loyalty program have been described in detail, it will be apparent that it provides several advantages over prior art customer loyalty programs, including the following:

(i) By linking the accrual of loyalty points to a discounted rate of interest applied to the customer's loan or other financial instrument, the incentive for earning at least the threshold level of loyalty points is substantially increased;

(ii) By applying a discounted rate of interest to eligible participating customers only, the loyalty of participating customers is rewarded directly, rather than all customers being rewarded indiscriminately as in some prior art programs; and

(iii) The customer loyalty program can be operated alongside of existing loyalty and incentive schemes, as another layer of benefits available to loyal customers.

(iv) The customer loyalty program can be varied as required especially for marketing purposes, such as by offering bonus loyalty points for the purchase of an item on a special offer.

It will be readily apparent to persons skilled in the relevant arts that various modifications and improvements may be made to the foregoing embodiments, in addition to those already described, without departing from the basic inventive concepts of the present invention. For example, customers may also join the loyalty program without the transfer or undertaking of mortgages, loans, credit cards or other financial instruments and may be entitled to loyalty rewards in the form of goods and services. Therefore, it will be appreciated that the scope of the invention is not limited to the specific embodiments described.

1. A method of operating a customer loyalty program, the method comprising:
registering a unique identifier allocated to a customer participating in the customer loyalty program;
establishing a customer loyalty account linked to said unique identifier for accumulating customer loyalty points earned by the participating customer;
transferring or establishing a financial instrument for the participating customer to/with a participating institution of a first type;
awarding customer loyalty points to the participating customer based on the value and/or quantity of purchases performed by said customer with one or more participating institutions of a second type using their unique identifier;
providing a discounted rate of interest applied to said financial instrument based on said customer achieving a predetermined loyalty point threshold within a periodic specified time interval; and
monitoring said customer loyalty account to ensure that the total of the loyalty points accrued during each one of said periodic specified time intervals exceeds said predetermined threshold whereby the customer may continue to enjoy the benefit of said discounted rate of interest applied to said financial instrument.

2. A method according to claim 1 wherein the first type of participating institution is a financial institution such as a bank, building society or insurance company.

3. A method of operating a customer loyalty program according to claim 2 wherein the financial instrument is a financial debt instrument such as a mortgage, loan, overdraft or credit card.

4. A method according to any one of claims 1 to 3 wherein the second type of participating institution is a retail institution such as a supermarket chain, fast food chain, electrical goods business or personal services company, or a business engaging in internet based commerce.

5. A method of operating a customer loyalty program according to any one of the preceding claims wherein said step of monitoring said customer loyalty account also involves resetting the balance of points in the customer loyalty account by at least the predetermined loyalty points threshold at the end of each said periodic specified time interval.

6. A method according to any one of the preceding claims wherein loyalty points accrued in excess of said predetermined loyalty point threshold can be carried forward into subsequent periodic specified time intervals.

7. A method according to claim 1 wherein in the event that the predetermined threshold is not reached in the periodic specified time interval, an adjustment is made retrospectively in the discounted interest rate applied during that period, charged back at normal or non-discounted rates.

8. A method according to claim 7 wherein in any subsequent periodic specified time interval, immediately following the period in which the predetermined threshold in the participating customer's loyalty account was not reached, the customer does not receive said discounted rate of interest on their financial instrument.

9. A method according to claim 7 or claim 8 wherein no limit is set on the number of periodic specified time intervals during which the customer may fail to reach the predetermined threshold of loyalty points.

10. A method according to any one of claims 1 to 6 wherein loyalty points accrued by participating customers above the predetermined threshold entitles them to further discounts, vouchers, incentives and benefits.

11. A method according to any one claims 1 to 6 wherein if the loyalty point account balance of a customer reaches beyond a minimum threshold limit within a periodic specified time interval, the customer is awarded separate status points which are transferred to a separate status point account.

12. A method according to claim 11 wherein upon achieving a predetermined threshold level of status points the participating customer is entitled to accrue loyalty points at a higher rate.

13. A method according to claim 1 wherein the customer is entitled to another type of benefit, discount or promotion offered by the participating institutions instead of or as well as the usual loyalty points awarded for the transaction.

14. A method according to claim 13 wherein a participating institution may alter the value or number of loyalty points earned by customers in a particular transaction.

15. A system for operating a customer loyalty program, the system comprising:
means for allocating a unique identifier to a customer participating in the customer loyalty program;
means for establishing a customer loyalty account linked to said unique identifier for accumulating customer loyalty points earned by the participating customer;
means for transferring or establishing a financial instrument for the participating customer to/with at least one participating institution of a first type;
means for awarding customer loyalty points to the participating customer based on the value and/or quantity of purchases performed by said customer with one or more participating institutions of a second type using their unique identifier;
means for providing a discounted rate of interest applied to said financial instrument based on said customer achieving a pre-determined loyalty points threshold within a periodic specified time interval; and
means for monitoring said customer loyalty account to ensure that the total of the loyalty points accrued during each subsequent one of said periodic specified time intervals exceeds said predetermined threshold whereby the customer may continue to enjoy the benefit of said discounted rate of interest applied to said financial instrument.

16. A system according to claim 15 wherein the first type of participating institution is a financial institution such as a bank, building society or insurance company.

17. A system according to claim 16 wherein the financial instrument is a financial debt instrument such as a mortgage, loan, overdraft or credit card.

18. A system according to claim 16 or claim 17 wherein the participating financial institution is able to access the customer loyalty account in order to confirm the continuing eligibility of a customer to a discounted rate of interest on the financial instrument.

19. A system according to any one of claims 15 or claim 16 wherein the second type of participating institution is a retail institution such as a supermarket chain, fast food chain, electrical goods business or personal services company, or a business engaging in internet based commerce.

20. A system according to claim 19 wherein the participating retail institution is provided with a verification means for verifying a customer's unique identifier in order to facilitate the customer's purchases.

21. A system according to claim 20 wherein the verification means is in the form of a magnetic card reader.

22. A system according to any one of claims 19 to 21 wherein the retail institution is further provided with an input device to facilitate the transfer of purchase information relating to the customer's purchases.

23. A system according to claim 22 wherein the input device is a data transmission device with built-in modem to facilitate the transmission of the customer's purchase information over the public telephone network.

24. A system according to any one of claims 15 to 23 wherein any one participating institution may embody both types of institution.

25. A system according to any one of claims 15 to claim 24 wherein the means for awarding customer loyalty points includes a facility to allow the participating institution to vary the value and/or number of loyalty points awarded.

26. A computer system for operating a customer loyalty program, the computer system comprising:
a data processing facility for processing information relating to identification of participating customers, information relating to participating institutions of a first type to which financial instruments are transferred or established for participating customers, information relating to participating customers' loyalty accounts wherein the loyalty accounts include loyalty points awarding to the participating customer based on the value and/or quantity of purchases performed by said customer with one or more participating institutions of a second type using their unique identifier, and information relating to customer's financial instruments;
a storage facility for storing a database of participating customers' information, a database of participating institutions' information, a database of participating customers' loyalty accounts, and a database of customer's financial instruments information;
a facility for managing the transfer of relevant information from participating customers and institutions and for managing the maintenance of said database information stored in said storage facility, including the application of discounted rates of interest to selected financial instruments; and,
a facility for monitoring said database of customers' loyalty accounts to ensure that the total of the loyalty points accrued during periodic specified time intervals is maintained above a predetermined threshold whereby customers may continue to enjoy the benefit of said discounted rates of interest applied to said selected financial instruments.

27. A computer system according to claim 26 wherein the system further comprises a facility for managing on-line access of information stored in the storage facility.

28. A computer system according to claim 26 or claim 27 wherein the financial instrument is a financial debt instrument such as a mortgage, loan, overdraft or credit card.

29. A method of operating a customer loyalty program substantially as herein described with reference to and as illustrated in the accompanying drawings.

30. A system for operating a customer loyalty program substantially as herein described with reference to and as illustrated in the accompanying drawings.

31. A computer system for operating a customer loyalty program substantially as herein described with reference to and as illustrated in the accompanying drawings.
